(19) United States
(12) Patent Application Publication
(10) Pub. No.: US 2004/0019249 A1
(43) Pub. Date: Jan. 29, 2004

(54) Process for reductive deposition on a metal surface

(76) Inventor: Friederich Bolsing, Lindhorst (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/457,340

(22) Filed: Jun. 9, 2003

(30) Foreign Application Priority Data
Jun. 7, 2002 (JP) 2002-166804

(51) Int. Cl. A62D 3/00

(52) U.S. Cl. 588/205

(57) ABSTRACT

The invention is directed toward a process for reductively depositing inorganic and/or organic compounds on the surface of a reducing metal. During the process, toxic and carcinogenic compounds become immobilized on a reducing metal and have their chemical hazard potential significantly decreased. The compounds' immobilization results from complex formation between the compounds with the reducing metal. The reduction of the immobilized compound may then be completed by contacting the compound-metal complexes with a hydrogen source.

The present invention relates to a process useful to chemically reduce inorganic and organic compounds, mainly in the field of detoxification and immobilization of toxic materials. Through the reductive decomposition of the toxicity structures of organic compounds and through the reductive immobilization of toxic inorganics the hazard potential of said toxic compounds is being significantly decreased. Vivid examples are the detoxification of halogenated organics like polychlorinated biphenyls (PCBs) and polychlorinated dibenzodioxins or dibenzofurans (dioxins) through reductive dehalogenation yielding the corresponding harmless hydrocarbons and the hydrogenation of carcinogenic polycyclic aromatics yielding the corresponding harmless aliphatic derivatives. Another example is the immobilization of water soluble heavy metal compounds by means of reduction to yield the water-insoluble heavy metal.

Reduction is a very basic chemical reaction and is described already in great detail in inorganic and organic chemistry textbooks. There is also a lot of other prior art documents, mainly with respect to the reductive dehalogenation of PCBs, and the like, with metals, in particular with alkali metal. Sometimes metals are used alone but mostly in conjunction with a hydrogen source. According to the Australian PL 6474 and PL 9085 halogenated organics are mechanochemically destroyed through grinding with metals alone or in the presence of a hydrogen source. U.S. Pat. No. 4,639,309 gives an example for the application of sodium and potassium in a molten form, i.e. at temperatures higher than 100° C. together with sand as an aid to abrasively remove formed alkali metal chloride from the surface of the alkali metal; this process resembles the old DEGUSSA process for the dehalogenation of PCBs in mineral oil with molten sodium, however without sand, and the like, at temperatures about 300° C. Since with all these methods a complete fragmentation takes place down to carbides and even carbon, the corresponding hydrocarbons cannot be isolated.

Other processes make use of reducing metals together with different types of hydrogen sources, for instance U.S. Pat. Nos. 4,853,040, 4,950,833, 4,973,783, 4,950,833, EP 0099951, 0 225 849, DE 34 10 239, 199 03 986, CH 668 709, Can. Appl. 20 26 506. These dehalogenation approaches involve some major disadvantages. If an alkali or earth alkali metal is applied in a liquid system, the hydrogen source must be of low acidity in order to prevent the metal from being consumed uselessly in a competition reaction with a hydrogen source being more reactive than the halogen compound. Thus the utilization of a simple inexpensive alcohol, like methanol, as a hydrogen source is not possible. Hydrogen sources of low acidity, however, for example polyethers and aliphatic primary or secondary amines, are very expensive and render the whole process uneconomic. Moreover, the particularly effective and thus generally preferred primary amines as a hydrogen source give rise to the formation of amino derivatives which are, at least, as toxic as the original halogenated parent compounds. A more favorable method is described in DE 199 03 986, in which the amines are used in their capacity as an electron transfer accelerator in substoichiometric catalytic quantities only, together with inexpensive hydrogen sources, thus suppressing the formation of toxic amino derivatives. Best results in this regard are achieved with tertiary amines which, of course, are not able to form toxic derivatives.

The reduction of polycyclic aromatic compounds, e.g. carcinogenic benzo[a]-pyrene, could be carried out in the well-known Birch reaction or in its variants, i.e. in liquid ammonia at temperatures between −33° C. and −50° C. or in the presence of amines which are said to form what is called “solvated electrons”. These processes may be useful at a laboratory scale but are not practical for large scale implementation and not at all in the context of waste treatment.

The aforementioned deficiencies of the prior art methods for reducing organic compounds, particularly halogenated organics and polycyclic aromatics, have been overcome in accordance with the present invention. It has also turned out that the reductive deposition method according to the present invention can also be applied to the reduction of inorganic compounds for removal and immobilization respectively.

It has been found in accordance with the present invention that a reducing metal in a very first reaction step complexes reducible organic compounds selectively before the actual reducing reaction takes place.

For instance, pieces of sodium, suspended in a hydrocarbon solvent, react immediately with an excess of added propanol yielding the stoichiometric quantity of hydrogen, a process which is accompanied by a steep rise of temperature. If one adds now just traces of a reducible organic compound, for instance, trichlorobenzene (TCB), the formation of hydrogen is immediately being stopped, whereas the same steep rise of temperature can be observed indicating an ongoing exothermic chemical process. No visible reaction product is being formed, such as sodium chloride. This is a very surprising observation, because it is well-known that sodium reacts with alcohols very vigorously and it could not at all be expected that in a solution containing a large excess of highly reactive alcohol but only a small amount of low reactive TCB, the latter would selectively be picked up by the sodium to stop any further chemical reaction. In other words, it could not be expected that in an unfavorable competitive interaction between a reducing metal and an H—O-bond on the one hand and a Cl—C-bond on the other hand the less reactive would win.

Actually, sodium being in a hydrocarbon solution together with traces of TCB but with a large excess of alcohol collects highly selectively the reducible organic compound TCB through reductive deposition of the TCB on the sodium surface. A molecular layer is being formed which completely inhibits any further reaction of the greater proportion of unreacted sodium, still present below the inhibiting molecular layer, with the excess of alcohol, also still present.

The thus discovered inhibiting first reaction product of an interaction between the aromatic system and the metal seems to be a CT-complex, in which one electron from the metal has been transferred into the first antibonding orbital of the aromatic compound but has not been located to the Cl—C-bond to form an ion radical or even sodium chloride as visible reaction products. Surprisingly, the inhibiting layer cannot simply be removed through agitating, for instance with a magnetic stirrer and even not, if some steel balls are additionally added.

Accordingly, since said reductive deposition by means of complex formation resulting in the formation of an inhibiting molecular layer suppresses any further reaction of the sodium, the concentration of TCB in said solution is being decreased only to that extent which corresponds to the TCB proportion reductively deposited on the actually available sodium surface area. In order to completely react the full quantity of said TCB with the sodium present, the sodium surface must be, in accordance with the present invention, continuously mechanically in situ recovered to achieve an ongoing reductive deposition and to end up in a complete collection of the whole quantity of TCB by complex formation.

Analogous interactions occur with any other reducible organic compound wherein “reducible” becomes the meaning of being able to preferably and selectively take up an electron from the reducing metal into a low-energy orbital under complex formation. Compounds of this sort are unsaturated aliphatics or alicyclics, aromatics, in particular, polycyclic aromatics, halogenated compounds, aldehydes or ketones, nitro compounds.

It becomes also clear from this observation, that the same mechanism must be true of an electron transfer from a metal owning a more negative normal electrode potential to one having a more positive potential resulting in an inhibiting plating effect on the electronegative metal. It is true that this last mechanism is well-known, e.g. from galvanization processes, but is has not been utilized for heavy metal immobilization in contaminated materials in accordance with the present invention so far. Both processes, complex formation of reducible organics and electrodeposition of reducible inorganics, can be covered by the expression “reductive deposition” of an inorganic or organic reducible compound on a metal surface.

According to these findings, the basic principles of the present invention can easily be outlined by way of example for the reductive dehalogenation of, for example, TCB and the immobilization of a heavy metal, for example copper in the form of a copper salt as a contaminant.

Collecting and chemically reducing TCB as a reducible organic in a liquid system by means of complex formation on a continuously mechanically in situ recovered metal surface to yield benzene can be achieved with any agitating system, which generates high shearing forces, preferably a high-speed dispersing tool, for instance, an IKA Ultra-Turrax T 25 with the dispersing tool S 25 N-18G. With this tool TCB in a liquid solution can completely be collected applying the stoichiometric quantity of sodium plus 10% excess in less than 10 min, even at the lowest speed being 11000 1/min.

Sodium as well as potassium are ductile and agglomerate at room temperature partially between rotor and stator of the dispersing tool thus hindering the free passage of finely dispersed particles. In this case most of the dispersing time is necessary to disperse the initially present coarse pieces of sodium down to a particle size which can easily pass the space between rotor and stator of the S 25 N-18G tool. However, finely dispersed sodium on pulverulent aluminum, magnesium or calcium, iron, preferably on iron powder made from iron carbonyls, activated carbon, graphite, non reducible plastic powders or pellets, e.g. polyethylene, polypropylene, and the like, prepared in a Retsch planetary ball mill S1 through grinding, for instance in the ratio of 2:1, together with a grinding aid, e.g. 0.5% of stearylamine, does need only about 3 min at room temperature to collect the total quantity of TCB. If one stops the dispersing tool after said time, there is a spontaneous phase separation and a sample of the clear and colorless liquid phase, taken by means of a syringe, contains no GC-detectable quantity of TCB.

The ground mix of the reducing metal and said pulverulent carrier component is pyrophoric and must be handled carefully, preferably under nitrogen. For better handling properties the mix containing the highly activated reducing metal may be coated. This can be achieved through grinding with a temporarily inertizing organic material, such as paraffin wax, or through spraying said paraffin wax on the ready mix under nitrogen.

Applying combinations of highly reactive metals like lithium, sodium and potassium along with less reactive pulverulent metals, like iron and aluminum, is of great significance because of the increased total metallic surface available for adsorption and subsequent electron transfer and thus for a faster reductive fixation through complexing on a larger metallic surface.

Whilst graphite works like a metal, activated carbon serves mainly as an adsorbent which helps adsorptively collecting the TCB for fast subsequent complex formation on the incorporated sodium surface.

The reductively fixed complex of the reducing metal and the reducible organic compound TCB, to go on with the example, can subsequently be reacted with a hydrogen source in situ or in a separate step after separation by decantation, centrifugation, filtration to yield the corresponding hydrocarbon. For instance, in order to recover a PCB contaminated mineral oil for reuse the stoichiometric quantity of sodium on aluminum is dispersed for some minutes in the liquid using an Ultra-Turrax dispersing tool. After switching off the tool the solids separate spontaneously and the clean oily phase can be recovered by decantation or centrifugation. The separated solids can be disposed of after having reacted with a hydrogen source in a separate reactor.

The cheapest, however most reactive hydrogen source is water. Since there might be still an excess of highly reactive sodium a less reactive mix of water and an inexpensive alcohol will generally be applied, e.g. water and methanol.

In case of the addition of a carbon source, e.g. a formaldehyde, acetone, carbon dioxide, the corresponding alcohol and carboxylic acid respectively are formed. Of course, in this case no excess of lithium, sodium or potassium will be applied in the complex formation step.

If the halogenated organic compound, e.g. dioxins, is present as a contaminant in a solid mix or solid solution a clean metal surface is continuously being generated in situ by means of intensive mixing devices the shearing forces of which are high enough to ensure not only the formation of a continuously recovered clean metal surface but guarantees also an effective mechanical cracking of coarse constituents and a fast meeting of a said clean metal surface area with the dioxins, for instance, with dioxins incorporated in vitreous fly ash from waste incinerators.

Mixing devices which meet these requirements are triturator mills, horizontal or vertical ball mills, for instance the Eirich MaxxMill and the Kubota Tower Mill; vibratory ball mills, cutting mills, beater mills, an extruder or kneader bringing about considerably high shearing forces.

The rate determining step in collecting reducible organics etc. in solids, in particular of dioxins in fly ash, goes parallel to the mobilizing rate of said compounds. Dioxins are mainly incorporated in vitreous solid fly ash particulates and will not readily be available for complex formation. In order to gain access to the incorporated dioxins, the coarse particulates must be cracked down completely to release the dioxins. The demand of time for this process is much higher than the time necessary for complex formation. Accordingly, grinding the fly ash, for instance, with sodium in the presence of a hydrogen source as described in some of the prior art documents is absolutely counterproductive and uneconomic because the hydrogen source consumes the greater deal of the sodium uselessly. In view of the basic principles of the present invention it becomes clear that all attempts to increase the rate of dehalogenation by means of adding a higher quantity of sodium, as described in some of the prior art documents, must have failed, because the sodium faces the hydrogen source and reacts with it, without having the chance to attack the dioxins hidden inside the vitreous fly ash particulates. Not to forget that the hydrogen source in this case cannot at all be water or an alcohol because these compounds would instantly and completely consume any present quantity of sodium producing mere hydrogen gas.

According to the basic principles of the present invention, the fly ash is being ground just with sodium, i.e. without the addition of any sort of hydrogen source, as long as necessary for the coarse fly ash particulates to completely release the inclosed dioxins for complexing. Of course, the rate of complex formation depends on the number of collisions between free dioxins and free metal surface too. The main factor regarding the total rate, however, is the time necessary to completely destruct coarse particles. This figure depends exclusively on the effectiveness of the grinding device and ranges for a Retsch mill or tower mill from, e.g. one hour to one and a half. The break-down of coarse particles can be supported through the addition of a grinding aid. The grinding aid must be a compound which cannot serve as a hydrogen source. An preferred grinding aid is a long-chain amine, e.g. stearylamine, which has the shape of a ball in which the amino group is protected by the surrounding hydrocarbon chain.

In order to mobilize the dioxins present in a solid matrix a small proportion of an inert solvent may be added, which supports the release of dioxins through extraction. The addition of a liquid solvent may cause caking in the mill. Therefore, the liquid solvent is advantageously replaced with solid solvents, like inert plastics in the form of powders or pellets, e.g. polyethylene, polypropylene, and the like. The chemical affinity of said organic polymers for dioxins is higher than that of inorganic solids.

In solids the complex of a reducing metal and a reducible organic compound can, generally, not be separated. Accordingly, the final reaction with a hydrogen or carbon source to yield the corresponding hydrocarbon and hydrocarbon derivative respectively must be carried out in the ground mix containing said complex. This can be done either in a subsequent processing step in the same device, where grinding has taken place, or, preferably, in a second in-line device.

The advantage of a separate in-line mixing device is the higher flexibility with respect to process heat control. In case of reacting the formed complex in the presence of an excess of sodium with a hydrogen source consisting of, for instance, a mixture of water and methanol, a great deal of reaction heat must be dissipated within a short period of time. This can be handled more easily in a separate in-line mixing device playing the role of a thin-film reactor which allows a very effective and well controllable heat dissipation. Thus large quantities of treated solids produced in a relatively small preceding mixing device, for instance in a tower mill, can be subjected to the subsequent more time consuming solvolysis in an appropriately designed separate device, in which, as an additional advantage, the temperature can be maintained in a range in which residual agents and reaction products cannot evaporate.

If particularly coarse materials, containing the reducible compounds, are to be treated according to the present invention, it might be advantageous to initially pretreat the contaminated material in a coarse crushing device before it is transferred into a subsequent refining mixing or grinding device along with the reducing metal. Thus, in total, a much smaller particle size can be obtained economically. The effectiveness of these processing steps can also significantly be increased through the addition of a grinding aid or an organic solvent or a mix of the same.

The present invention refers also to the chemical reduction of inorganic compounds, preferably of heavy metals as contaminants. Heavy metals cannot be detoxified by degradation as it is possible for organics. Nevertheless, their hazard potential can be minimized through immobilization and chemical fixation, which considerably decreases their bioavailability. Whereas heavy metal salts are water soluble, the chemically reduced form, i.e. the elemental metal, is insoluble. Fortunately, all toxic heavy metals have a more positive reduction potential than the alkali and alkaline earth metals as well as aluminum and iron. Accordingly, heavy metals like Cd, Pb, Cu and Hg in their ionic form will be chemically reduced by said reducing metals to yield the insoluble heavy metal. The process is the same as described for the reaction of said reducing metals with reducible organic compounds, the first step being an electron transfer from the reducing metal to the heavy metal compound. Thus, as a very first interaction product, a layer of the chemically deposited heavy metal on the reducing metal is being formed, which inhibits the reducing metal surface from further reaction. Accordingly, the full reduction capability of the reducing metal can be exhausted only by means of a continuously mechanically in situ recovered clean surface.

This means that in the case of solids, for instance waste incinerator fly ash, which are contaminated not only with dioxins as organics but also with mercury, cadmium and lead as hazardous inorganic compounds, just one process, i.e. the reductive deposition of reducible compounds as described in the present invention can be applied to solve both problems in one processing step.

According to the principles of the present invention said heavy metals can also be completely immobilized through reducing metals if the former are present as contaminants in liquids, liquid waste or in sludge, mud, sediments, and the like. In order to avoid reoxidation of the finely dispersed heavy metals, additional measures must be taken to prevent them from being remobilized. This can be achieved in the case of a contaminated soil or sediment through, for instance, forming a compacted hydrophobic dispersed chemical reaction body of soil for disposal or for technical and soil mechanical reuse in a sealed system. For further information see D. L. Wise et al., Remediation Engineering of Contaminated Soils, (p. 849 to 929) Marcel Dekker, New York, 2000.

Heavy metals in waste water can completely be removed through reductive deposition on finely dispersed aluminum intensively agitated with an Ultra-Turrax T 25 equipped with the dispersing tool S 25 N-18G. Since the aluminum is neither ductile nor brittle, it takes much more time to continuously mechanically recover a clean aluminum surface through the removal of the formed copper layer despite the fact that this layer is extremely thin and almost invisible. Very surprisingly, the same electron transfer accelerators which are effective in accelerating complex formation of organic reducible compounds can be applied here. Thus, a complete removal of copper, even in the form of its tetramine complex, can be achieved within a few minutes through agitating its aqueous solution by means of said Ultra-Turrax device in the presence of an aliphatic amine. It is known that amines substantively coat metal surfaces and this might be the reason for a fast electron transfer and an easier displacement of the copper layer from the reducing metal surface. The same principle, i.e. the supporting effect of amines on the reductive deposition of heavy metals can be applied for a fast immobilization of heavy metals in any other sort of material, in particular in solid waste, contaminated soil, and the like.

If the reducible compounds are present as contaminants in industrial waste, residues, by-products as well as in contaminated soil and soil-like materials, sludge, mineral oil and mineral oil-like materials, wet and which may be interspersed with foreign bodies, a direct chemical treatment according to the present invention is not possible in this sort of heterogeneous systems. Nevertheless, said contaminated materials will become treatable after having been worked up in a dispersed chemical reaction with or without an additional drying step. Through the dispersed chemical reaction processing step all said materials are transferred into a dry powder, which can easily be separated from any unwanted impurities by screening. For a detailed description of the DCR Technology see, for instance, D. L. Wise et al., Remediation Engineering of Contaminated Soils, (p. 849 to 929) Marcel Dekker, New York, 2000.

The pulverized material gained from the DCR (dispersed chemical reaction) step, may still contain some moisture and must, therefore, be dried before treated with alkali metals.

Now that preferred embodiments of the invention have been described in detail, it will be apparent to persons skilled in the relevant arts that numerous variations and modifications can be made without departing from the basic inventive concepts. Thus, for example, whilst each of the above-described examples involved a laboratory scale mixing/grinding/milling/dispersing device and small samples of contaminated material and reagents, it will be obvious to the skilled addressee that the process involving a continuous mechanical in situ recovery of metallic surfaces for reductive deposition of reducible organics and inorganics can be appropriately modified and applied on a larger scale to enable commercially viable detoxification and immobilization as well as other reduction processes for industrial purposes. All such modifications and variations are considered to be within the scope of the present invention, the nature of which is to be determined from the foregoing description. Furthermore, the preceding examples are provided to illustrate specific embodiments of the invention and are not intended to limit the scope of the process of the invention.

### EXAMPLES

1. Removal of TCB from a Liquid Solution

300 mg of sodium (stoichiometric quantity+about 10%), cut to the form of small cubes, was added to a solution of 362 mg (2 mmol) TCB in 50 ml cyclohexane being in a three neck flask equipped with an IKA Ultra-Turrax T 25 with dispersing tool S 25 N-18G and agitated under nitrogen at room temperature with a rotational speed of 11000 rpm for 8 min. The appearance of the metallic shining sodium surface turns into pale-gray. After the solid phase has spontaneously separated a colorless liquid sample was taken, which contains no TCB or di- or monochlorobenzene in a GC-detectable quantity.

Variant 1:

The same quantity of TCB was reacted in the same way with 300 mg of sodium on 150 mg of pulverulent aluminum as a metallic carrier yielding complete removal of TCB within 3 minutes. Sodium on aluminum was manufactured through a 15 min grinding of a 2:1 mix of both components together with 0.5% of stearylamine in a Retsch planetary ball mill S1 in a 50 ml steel grinding jar with 3 steel balls. The grinding jar was opened and the reagent proportion was taken inside a glove box under nitrogen.

Variant 2:

The process according to variant 1 was repeated in the presence of 70 mg of n-butylamine. The initially colorless liquid phase of the suspension becomes brownish-red within a few seconds and the reaction is apparently more vigorous through the addition of the amine because of its capacity as an electron transfer accelerator and by its substantive coating properties.

The solid residues containing residual sodium and aluminum respectively together with the reductively deposited but still not dehalogenated TCB is subjected to a reaction with methanol to yield the corresponding dehalogenated hydrocarbon. The same result can be obtained through the addition of said methanol to the original suspension after the complex formation between TCB and sodium has fully been completed.

2. Reductive Dehalogenation of TCB in a Solid Matrix

500 mg of sodium (stoichiometric quantity+about 20%) was added to a homogeneous mix of 544 mg (3 mmol) TCB in 100 g of a soil-like solid (Millisil W8) and ground in a Retsch planetary ball mill S1 in a 500 ml steel grinding jar with 4 steel balls at ambient temperature in the presence of 0.5% of stearylamine. After a 30 min grinding time the jar was opened for control. The initially pale sandy color of the mix had turned to pale-gray. After an additional 30 min of grinding the color had turned to grayish-black. Since the ground mix on exposure to air heats up rapidly to about 80° C.; the jar must be opened and samples must be taken under nitrogen in order to avoid any evaporation of TCB or partially dehalogenated products. One tenths of the whole mix was reacted in a second step in a three neck flask equipped with a magnetic stirrer and reflux condenser under nitrogen in a cooling bath with some excess of methanol to yield the corresponding reductively dehalogenated hydrocarbon. After extraction of the resulting mix by means of a Soxhlet extractor with n-pentane a GC-analysis of the colorless solution showed no detectable quantity of TCB or any other organic halogen containing compound.

3. Reductive Immobilization of Copper

To 100 ml of an aqueous solution of about one gram of copper acetate aqueous ammonia was added to form the dark-blue tetramine complex. A slight excess of pulverulent aluminum was added along with a small proportion of n-butylamine. The resulting suspension was agitated by means of the above specified Ultra-Turrax. The dark-blue color disappeared within some minutes indicating a complete reduction of the copper ions to elemental copper. After the Ultra-Turrax had been switched off the solids separate spontaneously. The aluminum shows a glance of copper. A reference sample treated in the same way but without the addition of amine has still its original dark-blue color.

1. A process for the reductive deposition of a reducible compound as such or as a constituent part of a mix or solution with a reducing metal characterized in that the reducible compound is continuously being reductively fixed on a continuously mechanically in situ recovered clean surface of a finely dispersed reducing metal at ambient temperatures.

2. A process according to claim 1, wherein the reducible compound is an organic compound as such or as a constituent part of a solid or liquid mix or solution and which is reductively fixed on a continuously mechanically in situ recovered clean surface of the reducing metal through complex formation.

3. A process according to claims 1 and 2, wherein the reducible organic compound is an unsaturated aliphatic or alicyclic compound, an aromatic compound, a halogenated compound, an aldehyde or ketone, a nitro compound, all as such or in the form of derivatives with additional functional groups or in the form of a solid or liquid mix or solution.

4. A process according to claim 1, wherein the reducing metal is lithium, sodium, potassium, magnesium, calcium, aluminum or iron, all as such or in the form of physical mixtures of the same or in the form of alloys of the same or in the form of mixtures or alloys with other metals or in the form of mixes with chemically inert compounds.

5. A process according to claims 1 and 4, wherein the chemically inert material is activated carbon, graphite, pulverulent or pelletized plastics.

6. A process according to claims 1, 4 and 5, wherein the reducing metal and the chemically inert material are intensively ground together in order to achieve a homogeneously dispersed reducing metal on the chemically inert material as a carrier.

7. A process according to claims 1 and 4, wherein one of the reducing metals is intensively ground together with another pulverulent reducing metal.

8. A process according to claims 1, 4 and 7, wherein lithium, sodium or potassium is intensively ground together with pulverulent aluminum or iron.

9. A process according to claims 1, and 4 to 8, wherein the reducing metal or the preparations containing the reducing metal is coated with a temporarily inhibiting layer.

10. A process according to claim 1, wherein the continuous mechanical in situ recovery of a clean surface of the reducing metal is achieved through the action of the shear forces of a high-speed stirrer or mixer or agitator or of a mechanical dispersing tool, triturator mill, horizontal or vertical ball mill, vibratory ball mill, cutting mill, beater mill, extruder or kneader.

11. A process according to claims 1 to 10, wherein the complex consisting of the reducing metal and the reducible organic compound in a liquid system is separated along with any excess of the reducible metal by means of decanting, centrifugation or filtration for a separate subsequent reaction with a hydrogen or carbon source.

12. A process according to claims 1 to 10, wherein the complex consisting of the reducing metal and the reducible organic compound in a solid system is reacted along with any excess of the reducing metal in a separate subsequent reaction with a hydrogen or carbon source.

13. A process according to claims 1 to 12, wherein the hydrogen or carbon source for the subsequent reaction of the complex consisting of a reducing metal and the reducible organic compound is water, aliphatic and alicyclic alcohols, phenols, amines, all as such or as derivatives containing additional functional groups or mixes of the same; haloorganics, aldehydes, ketones or carbon dioxide.

14. A process according to one of the preceding claims, wherein the subsequent reaction of the complex of a reducing metal with the reducible organic compound is carried out inside the mixing or grinding device, in which the chemical fixation of the reducible organic compound has taken place beforehand, or in a separate in-line mixing or grinding device.

15. A process according to one of the preceding claims, wherein solids containing the reducible compound are ground with the reducing metal in the presence of a grinding aid.

16. A process according to claim 15, wherein the grinding aid is a long-chain amine, polyvinyl amine or polyethylene imine.

17. A process according to one of the preceding claims, wherein solids containing the reducible organic compound are ground with the reducing metal in the presence of an inert organic solvent.

18. A process according to claim 17, wherein the inert organic solvent is a biodegradable organic solvent, pulverulent plastic or activated carbon.

19. A process according to one of the preceding claims, wherein solids, which contain the reducible organic compound incorporated, are pre-treated in an intensive mixing or grinding device in order to increase the accessibility of the reducible organic compounds through decreasing the particle size of solid particles.

20. A process according to claims 17, 18 and 19, wherein the pretreatment takes place in the presence of a grinding aid, an organic solvent or a mix of the same.

21. A process according to claim 1, wherein the complex formation takes place in the presence of a substoichiometric quantity of an aliphatic amine, an organic polymer containing primary and/or secondary and/or tertiary amino groups or a saturated alicyclic compound with nitrogen as a heterocyclic atom.

22. A process according to claim 1, wherein the reducible compound is an inorganic compound as such or as a constituent part of a solid or liquid mix or solution and which is reductively fixed on a continuously mechanically in situ recovered clean surface of the reducing metal through plating.

23. A process according to one of the preceding claims, wherein the inorganic compound is a salt or complex of a heavy metal.

24. A process according to one of the preceding claims, wherein heavy metal ions, as contaminants in a liquid phase, are transferred into their insoluble metallic state through reductive fixation on a continuously mechanically in situ recovered clean surface of the reducing metal and are thus completely removed from said liquid phase through intensive mixing by means of a high-speed dispersing tool in the presence of an electron transfer accelerator.

25. A process according to one of the preceding claims, wherein heavy metal ions as contaminants in solids are transferred into their insoluble metallic state through reductive fixation on a continuously mechanically in situ recovered clean surface of the reducing metal and thus completely immobilized in said solids by intensive mixing, grinding, milling in the presence of an electron transfer accelerator.

26. A process according to claims 24 and 25, wherein the electron transfer accelerator is an amine.

27. A process according to claims 24 to 26, wherein an additional precipitating agent is added and intensively mixed, ground, milled after the reductive deposition of the heavy metals on the surface of a reducing metal has been completed in order to prevent a remobilization of said heavy metals by reoxidation.

28. A process according to claim 27, wherein said precipitating agent is a sulfide formed through the in situ reduction of additionally added elementary sulfur, which reacts with an excess of the reducing metal during intensive mixing, grinding or milling.

29. A process for the detoxification and immobilization of reducible organic and inorganic hazardous compounds as contaminants in industrial waste, residues, by-products as well as in contaminated soil and soil-like materials, sludge, mineral oil and mineral oil-like materials characterized in that said contaminated materials are subjected to a process according to one of the preceding claims without pretreatment or after having been worked up in a dispersed chemical reaction and applying, if necessary, an additional thermal and/or chemical drying process.

30. A process according to claim 29, wherein said contaminated material, if interspersed with foreign bodies, is reacted in a dispersed chemical reaction followed by screen classification, and wherein the resulting homogeneous fine sievings are then, with or without an additional drying step, subjected to a process according to one of the preceding claims for the detoxification and immobilization of reducible organic and inorganic hazardous contaminants.
